(19) United States
(12) Patent Application Publication
(10) Pub. No.: US 2017/0156456 A1
(43) Pub. Date: Jun. 8, 2017

(54) METHOD OF PRINTING ON SILICONE BANDS

(71) Applicant: WATCHITUDE, LLC, New Brunswick, NJ (US)

(72) Inventors: ALBERT HAKIM, Eatontown, NJ (US); JAY TSE, Guangdong (CN)

(21) Appl. No.: 15/366,030

(22) Filed: Dec. 1, 2016

Related U.S. Application Data
(60) Provisional application No. 62/262,467, filed on Dec. 3, 2015.

(51) Int. Cl. A44C 5/00; B41J 2/01; G04B 45/00; B41J 11/00

(52) U.S. Cl. CPC A44C 5/0053; B41J 11/002; B41J 2/01; G04B 45/0076

(57) ABSTRACT

A band having a silicone surface with reduced static electric charge and a cured layer of dried UV oil varnish including an ink image is created by: treating the surface to remove static electric charge; coating the treated surface with a layer of UV oil varnish; allowing the varnish layer to dry; forming the image on the dried varnish layer; and curing the ink and varnish layer. A watch casing may be attached to the band. The band may be a slap band.

### BACKGROUND OF THE INVENTION

1. Field of the Invention

The present invention relates to bands made of silicone or having a silicone surface including slap bands and slap watch bands, and more particularly, to a method of printing full color, photographic quality imagery and designs on such bands.

2. Description of Prior Art Including Information Disclosed Under 37 CFR 1.97 and 1.98

Bands including conventional watch bands of various styles and shapes made from a variety of different materials are well known. Also known are so called “slap bands” which are bracelets consisting of layered, flexible stainless steel bistable spring band sealed within a fabric, silicone or plastic cover. A watch casing is or may be attached to the slap band. In some cases, interchangeable watch casings of different colors or styles may be used to provide greater fashion versatility.

Often the exterior surface of the band is printed with various patterns and/or colors for aesthetic purposes. However, when the band itself or in the case of a slap band the cover material, is made of silicone, printing of the silicone surface creates special problems because using conventional techniques to print does not render acceptable results.

In particular, conventional printing techniques result in the ink looking blurry when printed directly on the silicone surface of a band. Further, the ink tends to peel off when a varnish or film is applied directly to the silicone before printing.

Silk screen printed silicone bands for watches are currently available on the market. However, on those bands each color ink has to be applied individually, one at a time, and the result is not of photographic quality. Other techniques for full color printing on silicone bands for watches have proved to be unacceptable. The ink easily peels or wears off because the adhesion of the ink to the silicone band surface is poor.

The present invention relates to a process that makes it possible to print a practically indestructible, high quality, full color photographic quality image onto a silicone surface of a band.

### BRIEF SUMMARY OF THE INVENTION

For purposes of this specification, the word “band” is used to refer to any bracelet or similar article which can surround the wrist or other body part including a conventional watch band, a slap band or a slap watch band. Further the reference to a silicone “surface” is intended to include bands made in whole or in part of silicone as well as bands which have an exterior or cover layer of silicone, such a slap band.

The present invention relates to a method for printing an image on the silicone surface of a band. The method includes the steps of: treating the surface to remove static electric charge; coating the treated surface with a layer of UV oil varnish; allowing the varnish layer to dry; forming the image on the dried varnish layer; and curing the ink and varnish layer.

The step of treating the surface to remove static electric charge is performed by heating the surface, preferably by using a blow torch flame applied directly to the surface.

The step of coating the treated surface with a layer of UV oil varnish includes selecting the varnish to create a shiny or a matte finish.

The step of coating the treated surface with a layer of UV oil varnish is performed by spraying the varnish on the surface using a compressor. The varnish is sprayed on the surface more than one time, preferably multiple times in different directions.

The step of allowing the varnish layer to dry includes allowing the varnish layer to dry for about 20 minutes.

The step of forming the image on the dried varnish layer may be performed by conventional digital ink jet printing techniques using a large Epson flatbed printer or similar equipment or by image transfer processes.

The step of curing the ink and varnish layer includes heating the band, preferably to a temperature of about 120 degrees Celsius for about 40 minutes.

The method may further include attaching a watch to the band.

The image may be a pattern and/or one or more colors.

In accordance with another aspect of the present invention, a band is provided having a silicone surface with an imprinted image. The surface has a reduced static electric charge. A layer of dried UV oil varnish is situated on the surface. The image is formed by ink on the dried varnish layer. The dried varnish layer with the ink is cured. The band may be a band with a watch casing. It may be a slap band with a bistable metal interior.

### BRIEF DESCRIPTION OF THE SEVERAL VIEWS OF DRAWINGS

To these and to such other objects that may hereinafter appear, the present invention relates to a method of printing on silicone slap watch bands as described in detail in the following specification and recited in the annexed claims, taken together with the accompanying drawings in which:

FIG. 1 is a plan view of a slap band imprinted using the method of the present invention; and

FIG. 2 is a flow chart of the method of the present invention.

### DETAILED DESCRIPTION OF THE INVENTION

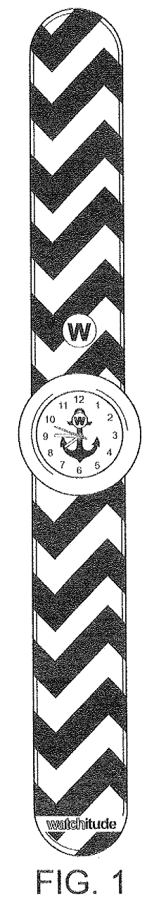

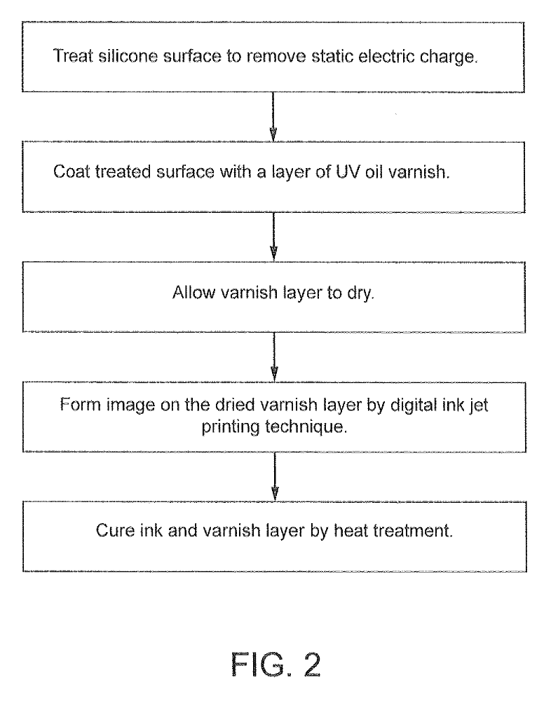

The image on the slap band of FIG. 1 is created by the method of the present invention as set forth in FIG. 2. For purposes of this specification, the term “image” should be construed in its broadest sense to include any pattern, design, picture, color or text which can be printed on a surface.

The slap band of FIG. 1 has a silicone surface with reduced static electric charge and a cured layer of dried UV oil varnish including an ink image formed over the surface. A watch casing is attached to the slap band.

As seen in FIG. 2, to begin the method, the silicone surface of the band is treated by heating to reduce or completely remove static electricity, preferably using a blow torch flame applied directly on the band surface.

The treated band surface is coated with a layer of UV oil varnish, preferably by spraying the oil onto the surface. The varnish may be sprayed onto the surface using a compressor. For best results, three or four coats of varnish are sprayed in different directions

The varnish may be selected create a shiny or a matte finish. The varnish may be any suitable commercially available product. One such product which has worked acceptably is PU shiny bonding oil available from Dongguan City AOC Rubber Trading Co., LTD of China.

The varnish is allowed to dry for a short period of time, about 20 minutes, depending upon environmental conditions.

After the silicone surface is prepared as indicated above, the image is formed on the surface. The image may be printed by conventional printing techniques including ink jet printing. Ink jet printing could be accomplished using a large Epson flatbed printer or similar machine. Water decals and similar image transfer processes in which designs would be printed on a surface, such as a film, and transferred by soaking in water or other liquid, and then applying the decal to the silicone surface, could also be used.

The varnish with the imprinted ink image is then cured. This is accomplished by heating in an oven for about 40 minutes at a temperature of about 120 degrees Celsius. The result is a silicone slap watch band with a durable, full color photographic quality image.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

We claim:

1. A method for printing an image on the silicone surface of a band comprising the steps of:
(a) treating the surface to reduce static electric charge;
(b) coating the treated surface with a layer of UV oil varnish;
(c) allowing the varnish layer to dry;
(d) forming the image by depositing ink on the dried varnish layer in the desired pattern; and
(e) curing the ink and varnish layer.

2. The method of claim 1 wherein the step of treating the surface to reduce static electric charge comprises heating the surface.

3. The method of claim 2 wherein the step of heating the surface is performed using a flame applied directly to the surface.

4. The method of claim 3 wherein the step of applying the flame to the surface is performed using a blow torch.

5. The method of claim 1 wherein the step of coating the treated surface with a layer of UV oil varnish comprises the step of selecting the varnish to create a shiny finish.

6. The method of claim 1 wherein the step of coating the treated surface with a layer of UV oil varnish comprises the step of selecting the varnish to create a matte finish.

7. The method of claim 1 wherein the step of coating the treated surface with a layer of UV oil varnish comprises the step of spraying the varnish on the surface.

8. The method of claim 7 wherein the step of spraying the varnish on the surface comprises spraying the varnish using a compressor.

9. The method of claim 7 wherein the step of spraying the varnish on the surface comprises the step of spraying the varnish more than one time.

10. The method of claim 7 wherein the step of spraying the varnish on the surface comprises the step of spraying the varnish multiple times in different directions.

11. The method of claim 1 wherein the step of allowing the varnish layer to dry comprises the step of allowing the varnish layer to dry for about 20 minutes.

12. The method of claim 1 wherein the step of forming the image on the dried varnish layer comprises the step of applying ink by a digital ink jet printing technique.

13. The method of claim 1 wherein the step of forming the image on the dried varnish layer comprises the step of applying ink using an image transfer process.

14. The method of claim 1 wherein the step of forming the image on the dried varnish layer comprises using an image transfer process.

15. The method of claim 1 wherein the step of curing the ink and varnish layer comprises the step of heating the layer.

16. The method of claim 15 wherein the step of heating the layer comprises the step of heating the layer to a temperature of about 120 degrees Celsius.

17. The method of claim 15 wherein the step of heating the layer comprises the step of heating the layer for about 40 minutes.

18. The method of claim 1 further comprising the step of attaching a watch casing to the slap band.

19. The method of claim 1 wherein the image comprises a pattern.

20. The method of claim 1 wherein the image comprises a color.

21. The method of claim 1 wherein the band is a watch band.

22. The method of claim 1 wherein the band is a slap band.

23. A band comprising a silicone surface with reduced static electric charge and a cured layer of dried UV oil varnish including an ink image situated on the silicone surface.

24. The band of claim 23 further comprising a watch casing.

25. The band of claim 23 wherein the band is a slap band.
